(19) United States
(12) Patent Application Publication
(10) Pub. No.: US 2025/0004724 A1
(43) Pub. Date: Jan. 2, 2025

(54) METHODS AND SYSTEMS FOR ESTIMATING A GRADIENT, AND METHODS AND SYSTEMS FOR CONSTRUCTING A PULSE PROGRAM

(71) Applicant: XANADU QUANTUM TECHNOLOGIES INC., Toronto (CA)

(72) Inventors: NATHAN KILLORAN, Toronto (CA); KORBINIAN KOTTMANN, Barcelona (ES)

(21) Appl. No.: 18/597,311

(22) Filed: Mar. 6, 2024

Related U.S. Application Data
(60) Provisional application No. 63/489,292, filed on Mar. 9, 2023.

(51) Int. Cl. G06F 7/60; G06F 17/12

(52) U.S. Cl. CPC G06F 7/60; G06F 17/12

(57) ABSTRACT

In methods and systems for estimating a gradient, a time-dependent unitary U and its derivative are computed with respect to a free parameter θᵢ within a time interval for a pulse program for a quantum system, θᵢ characterizing at least one of the pulse's shape, amplitude, phase, start time, and end time. The linear equation system ∂_{θ}_{ᵢ}U=U*iΩ is solved for the effective generator Ω that is an element of the dynamical Lie algebra generated by the evolution under the time-dependent unitary U. Ω is decomposed into a sum of operators Pₖ, and the gradient of the circuit expectation value of the quantum system is computed with respect to θᵢ for each operator Pₖ using a parameter-shift method. In a method for constructing a pulse program, a candidate pulse is added if its evolution generator commutes with all generators of all dynamical Lie algebras during the same time interval.

### CROSS-REFERENCE TO RELATED APPLICATIONS

This application claims the benefit of, and priority to, U.S. Provisional Patent Application No. 63/489,292, filed Mar. 9, 2023 and titled “Methods and Systems for Estimating a Gradient, and Methods and Systems for Constructing a Pulse Program”, the entire contents of which are incorporated herein by reference for all purposes.

### TECHNICAL FIELD

The present disclosure relates to quantum computing, and, in particular, to methods and systems for estimating a gradient, and methods and systems for constructing a pulse program.

### BACKGROUND

Quantum systems evolve in time according to a differential equation called the Schrodinger equation. This equation typically appears in two forms: the time-dependent Schrodinger equation ∂ₜ|ψ [symbol] =iH(t)|ψ [symbol] , and the time-independent Schrodinger equation of ∂ₜ|ψ [symbol] =iH|ψ [symbol] . The distinction between the two is whether the Hamiltonian H—the generator of evolution—is itself time dependent (H=H(t)) or not. The time-dependent Schrodinger equation is more general, and hence allows for the creation of evolutions that would not be as easily possible with time-independent Hamiltonians. However, solving the time-dependent Schrodinger equation can become much more complicated than solving the time-independent one.

In physical quantum devices, including quantum computers, quantum sensors, and quantum communication machines, access is available, at the lowest level, to various “knobs” that can be tuned. These knobs control the evolution of quantum systems (these may be qubits, or they may be systems with more than 2 levels) by allowing the programming of different Hamiltonians at different points during a computation. In the general case, these knobs are continuous, and may be continuously changed over time; i.e., they correspond to a time-dependent Hamiltonian. In the circuit model, this capability is usually abstracted away, either by restricting to the time-independent case—so the knobs discretely turn on or off, but otherwise do not vary continuously—or by using a time-dependent evolution under the hood which leads to an effective desired time-independent evolution.

A number of quantum computing hardware devices now expose this “analog control” layer to users, typically using the word “pulse” to describe the time-dependent control over time. This opens the opportunity to end users to program quantum devices in a more powerful way, by using time-dependent evolution instead of time-independent. However, the additional power that pulse programming provides comes with greatly increased program complexity.

This complexity is potentially at odds with another feature that is desirable for pulse programs: the computation of gradients of these programs. Gradients are important because they are the key enabler of variational quantum algorithms. In a variational algorithm, a user may specify the skeleton/scaffold of a program, while leaving certain parameters free. These parameters will then be optimized to specific values based on the minimization of some cost function, which may also include training data. When using the gradient descent algorithm for this optimization, it is beneficial to compute gradients with respect to the free parameters.

For pulses, these free parameters may be controlled in several ways. For example, the free parameters can be varied by controlling the shape, amplitude, phase, start/end time, duration, etc. of each pulse. There are two main requirements to overcome when working with gradient-based approaches to optimizing quantum circuits: a method to (efficiently) compute the gradients, and a method for controlling the pulse structure so that the gradients provide useful signal, i.e., they do not vanish.

It is desirable to create a novel pulse programming toolset for creating pulse programs which allows users access to pulse-level control, while intelligently managing and automating their programs in a way that enables such pulse programs to be differentiable. Further, it is desirable to provide a novel approach to estimating gradients.

### SUMMARY

In accordance with a first aspect of the present disclosure, there is provided a classical computer-assisted method for estimating a gradient on quantum hardware or a quantum hardware simulator, comprising: computing, via a classical computing system for a pulse program for a quantum system, a time-dependent unitary U and the derivative of the time-dependent unitary U with respect to a free parameter θᵢ within a time interval, the free parameter θᵢ characterizing at least one of a shape, an amplitude, a phase, a start time, and an end time of a pulse; solving the linear equation system ∂_{θ}_{ᵢ}U=U*iΩ for an effective generator Ω that is an element of the dynamical Lie algebra generated by the evolution under the time-dependent unitary U; decomposing the effective generator Q into a sum of operators Pₖ; and computing, on the quantum hardware or the quantum hardware simulator, the gradient of the circuit expectation value of the quantum system with respect to θᵢ for each operator Pₖ using a parameter-shift method.

In some or all examples of the first aspect, during the using of the parameter-shift method, the generalized parameter-shift rule is performed with 2R+1 shift terms, where R is the number of unique eigenvalue differences of Ω.

In some or all examples of the first aspect, during the using of the parameter-shift method, the parameter-shift gradient is computed for each operator Pₖ and the parameter-shift gradient for each operator Pₖ is combined classically.

In some or all examples of the first aspect, the time-dependent unitary U and the derivative of the time-dependent unitary U with respect to the free parameter θᵢ are calculated using numerical methods.

In a second aspect of the present disclosure, there is provided a computing system for estimating a gradient on quantum hardware or a quantum hardware simulator, comprising: at least one processor; memory storing machine-readable instructions that, when executed by the at least one processor, cause the computing system to: compute, for a pulse program for a quantum system, a time-dependent unitary U and the derivative of the time-dependent unitary U with respect to a free parameter θᵢ within a time interval, the free parameter θᵢ characterizing at least one of a shape, an amplitude, a phase, a start time, and an end time of a pulse; solve the linear equation system ∂_{θ}_{ᵢ}U=U*iΩ for an effective generator Ω that is an element of the dynamical Lie algebra generated by the evolution under the time-dependent unitary U; decompose the effective generator Ω into a sum of operators Pₖ; and compute, on the quantum hardware or the quantum hardware simulator, the gradient of the circuit expectation value of the quantum system with respect to θᵢ for each operator Pₖ using a parameter-shift method.

In some or all examples of the second aspect, the machine-readable instructions, when executed by the at least one processor, cause the at least one processor, during the use of the parameter-shift method, to perform the generalized parameter-shift rule with 2R+1 shift terms, where R is the number of unique eigenvalue differences of Ω.

In some or all examples of the second aspect, the machine-readable instructions, when executed by the at least one processor, cause the at least one processor, during the use of the parameter-shift method, to compute the parameter-shift gradient for each operator Pₖ and combine the parameter-shift gradient for each operator Pₖ classically.

In some or all examples of the second aspect, the time-dependent unitary U and the derivative of the time-dependent unitary U with respect to the free parameter θᵢ are calculated using numerical methods.

In a third aspect of the present disclosure, there is provided a classical computer-assisted method for constructing a pulse program for execution on quantum hardware or a quantum hardware simulator, comprising: receiving, via a computing system, a candidate pulse for a pulse program to be executed on a quantum computer, the candidate pulse having a time interval defined by a start time and an end time during which the candidate pulse is to be active, a function defining the shape of the candidate pulse, and an evolution generator; determining, via the computing system, if any pulses of the pulse program containing non-trivial dynamical Lie algebras are active during the time interval of the candidate pulse; in response to determining that no pulses containing non-trivial dynamical Lie algebras are active during the time interval of the candidate pulse, adding the candidate pulse to the pulse program; in response to determining that at least one pulse containing non-trivial dynamical Lie algebras is active during the time interval when the candidate pulse is active, determining, via the computing system, if the evolution generator of the candidate pulse commutes with all of the generators of the dynamical Lie algebras of the at least one pulse that is active during the time interval; and adding the candidate pulse to the pulse program if the evolution generator of the candidate pulse commutes with all generators of the dynamical Lie algebras of the at least one pulse that is active during the time interval.

In some or all examples of the third aspect, the method further comprises: in response to determining that the evolution generator of the candidate pulse does not commute with all of the generators of the dynamical Lie algebras of the at least one pulse that is active during the time interval, identifying a first set of subintervals of the candidate pulse for which the evolution generator is a proper element of one or more of the dynamical Lie algebras of the at least one pulse that is active during the time interval, and placing all other subintervals of the candidate pulse in a second set; determining, for each subinterval in the second set, if the evolution generator of the candidate pulse is expressible as a linear combination of the generators of the dynamical Lie algebras of the at least one pulse that is active during the subinterval; and adding the candidate pulse to the pulse program if the evolution generator of the candidate pulse is expressible as a linear combination of the generators of the dynamical Lie algebras of the at least one pulse that is active during each subinterval in the second set.

In some or all examples of the third aspect, the method further comprises: in response to determining that the evolution generator of the candidate pulse is not expressible as a linear combination of the generators of the dynamical Lie algebras of the at least one pulse that is active during each subinterval in the second set, determining a new dynamical Lie algebra within the time interval from adding the candidate pulse to the pulse program; determining if the cardinality of the new dynamical Lie algebra exceeds a cardinality threshold within the time interval; and adding the candidate pulse to the pulse program if the cardinality of the new dynamical Lie algebra is less than or equal to the cardinality threshold within the time interval.

In some or all examples of the third aspect, the method further comprises rejecting addition of the candidate pulse to the pulse program in response to determining that the cardinality of the new dynamical Lie algebra exceeds the cardinality threshold within the time interval.

In some or all examples of the third aspect, the method further comprises reporting an error for the candidate pulse in response to determining that the cardinality of the new dynamical Lie algebra exceeds the cardinality threshold within the time interval.

In some or all examples of the third aspect, the method further comprises estimating a gradient of the pulse program.

In some or all examples of the third aspect, estimating a gradient of the pulse program comprises solving a system of equations comprising one of ∂_{θ}_{ᵢ}U=U*iΩ or ∂ₜΩ=∂_{θ}_{ᵢ}U+i[Ω,U] for an effective generator Ω that is an element of the dynamical Lie algebra generated by the evolution under a time-dependent unitary U, θᵢ being a free parameter characterizing at least one of a shape, an amplitude, a phase, a start time, or an end time of a pulse of the pulse program.

In a fourth aspect of the present disclosure, there is provided a computing system for constructing a pulse program for execution on quantum hardware or a quantum hardware simulator, comprising: at least one processor; memory storing machine-readable instructions that, when executed by the at least one processor, cause the computing system to: receive a candidate pulse for a pulse program to be executed on a quantum computer, the candidate pulse having a time interval defined by a start time and an end time during which the candidate pulse is to be active, a function defining the shape of the candidate pulse, and an evolution generator; determine if any pulses of the pulse program containing non-trivial dynamical Lie algebras are active during the time interval of the candidate pulse; add the candidate pulse to the pulse program if no pulses containing non-trivial dynamical Lie algebras are active during the time interval of the candidate pulse; if at least one pulse containing non-trivial dynamical Lie algebras is active during the time interval when the candidate pulse is active, determine if the evolution generator of the candidate pulse commutes with all of the generators of the dynamical Lie algebras of the at least one pulse that is active during the time interval; and add the candidate pulse to the pulse program if the evolution generator of the candidate pulse commutes with all generators of the dynamical Lie algebras of the at least one pulse that is active during the time interval.

In some or all examples of the fourth aspect, the machine-readable instructions, when executed by the at least one processor, cause the at least one processor to: if the evolution generator of the candidate pulse does not commute with all of the generators of the dynamical Lie algebras of the at least one pulse that is active during the time interval, identify a first set of subintervals of the candidate pulse for which the evolution generator is a proper element of one or more dynamical Lie algebras of the at least one pulse that is active during the time interval, and place all other subintervals of the candidate pulse in a second set; determine if the evolution generator is expressible as a linear combination of generators accounted for in the dynamical Lie algebras of each subinterval in the second set; and add the candidate pulse to the pulse program if the evolution generator of the candidate pulse is expressible as a linear combination of the generators of the dynamical Lie algebras of the at least one pulse that is active during each subinterval in the second set.

In some or all examples of the fourth aspect, the machine-readable instructions, when executed by the at least one processor, cause the at least one processor to: if the evolution generator of the candidate pulse is not expressible as a linear combination of the generators of the dynamical Lie algebras of the at least one pulse that is active during each subinterval in the second set, determine a new dynamical Lie algebra within the time interval from adding the candidate pulse to the pulse program; determine if the cardinality of the new dynamical Lie algebra exceeds a cardinality threshold within the time interval; and add the candidate pulse to the pulse program if the cardinality of the new dynamical Lie algebra is less than or equal to the cardinality threshold within the time interval.

In some or all examples of the fourth aspect, the machine-readable instructions, when executed by the at least one processor, cause the at least one processor to reject addition of the candidate pulse to the pulse program if the cardinality of the new dynamical Lie algebra exceeds the cardinality threshold within the time interval.

In some or all examples of the fourth aspect, the machine-readable instructions, when executed by the at least one processor, cause the at least one processor to report an error for the candidate pulse if the cardinality of the new dynamical Lie algebra exceeds the cardinality threshold within the time interval.

In some or all examples of the fourth aspect, the machine-readable instructions, when executed by the at least one processor, cause the at least one processor to estimate a gradient of the pulse program.

In some or all examples of the fourth aspect, the instructions that cause the at least one processor to estimate a gradient of the pulse program include instructions to solve a system of equations comprising one of ∂_{θ}_{ᵢ}U=U*iΩ or ∂ₜΩ=∂_{θ}_{ᵢ}U+i[Ω,U] for an effective generator Ω that is an element of the dynamical Lie algebra generated by the evolution under a time-dependent unitary U, θᵢ being a free parameter characterizing at least one of a shape, an amplitude, a phase, a start time, or an end time of a pulse of the pulse program.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIG. 1 is a schematic diagram showing various physical and logical components of a computing system in accordance with example embodiments described herein.

FIG. 2 is a schematic diagram showing various components of a quantum computing system in accordance with example embodiments described herein.

FIGS. 3A to 3C show three exemplary time-dependent functions for Hamiltonians usable with the quantum computing system of FIG. 2.

FIG. 4 shows various time-dependent Hamiltonian pulses proposed for application to various subsystems of a quantum computing system, such as that of FIG. 2.

FIG. 5 is a flow chart of a general method of determining a gradient in accordance with some example embodiments described herein.

FIGS. 6A and 6B show a flow chart of a general method of determining whether a candidate Hamiltonian pulse can be added to a program in accordance with some example embodiments described herein.

Similar reference numerals may have been used in different figures to denote similar components. Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Quantum computing systems can receive analog input, providing continuous degrees of freedom of what is permitted. That is, instead of just enabling input via a set of switches, input can be provided via a set of dials that are not limited to being moved between discrete settings. A more standard way of thinking of effecting changes in states of quantum computing systems is via gates, which are either active or not active. In a pulse programming framework, however, inputs can be continuous over time to enable changing the energy imparted to the quantum system as is desired. Typically, input to a quantum computing system entails the controlling of electromagnetic fields, which interact with the quantum system and force it to evolve in different ways. This is referred to herein as pulse programming.

These switches or pulses are referred to generally as Hamiltonians. A quantum system evolves according to a Hamiltonian. On a quantum computer, the quantum system includes a set of qubits, and the Hamiltonian is enacted upon the qubits using a series of switches/gates/pulses. That is, a Hamiltonian represents the physical interactions that a qubit is subjected to, such as by the application of an electromagnetic field. A “pulse” refers to the time-dependent properties for each physical interaction that the qubits are subjected to; that is, the amplitude of the electromagnetic field, its direction, its frequency, its phase, and its polarization as a function of time. It is noted that a qubit is a physical piece of quantum hardware in a quantum computer, and the qubit can be a superconducting circuit, ions in a trap, etc.

In the context of pulse programming as discussed herein, a quantum algorithm is defined as a finite sequence of step-by-step instructions sent to the quantum hardware which realizes a Hamiltonian interaction to steer the state of the qubits to solve a particular problem upon measurement.

It is believed that quantum computing holds the promise of solving specific computational problems, which are deemed to be too challenging for conventional classical hardware. A computational task which is particularly well suited for quantum computing systems is the simulation of quantum mechanical systems. Another, perhaps more tangible, computational task that quantum computing systems are advantageous for is machine learning. In one example of machine learning, data is processed in order to locate associations between features or patterns of features and classifications. The data can be images, the features can include edges of particular shapes or a lack of edges in particular locations in an image, and the classifications can be types of objects detected in the image, such as specific characters of text. In processing the data, a cost function is evaluated in order to determine how to adjust parameters of a model that represents the relationships between the features or patterns of features and the classifications. The cost function can be an indicator of a fit between data being analyzed and a classification. In order to determine how to adjust the parameters, the differential of the cost function relative to the parameters is determined, thus providing a gradient of the cost function relative to the parameters. This gradient directs how the parameters should be adjusted in order to make the model better represent the relationship between the features or patterns of features and the characteristics based on the processed data, and thus better able to classify images as containing particular text characters.

It should be noted that machine learning is only one possible application of quantum computing, and other applications include quantum spin systems such as quantum magnets and combinatorial optimization problems.

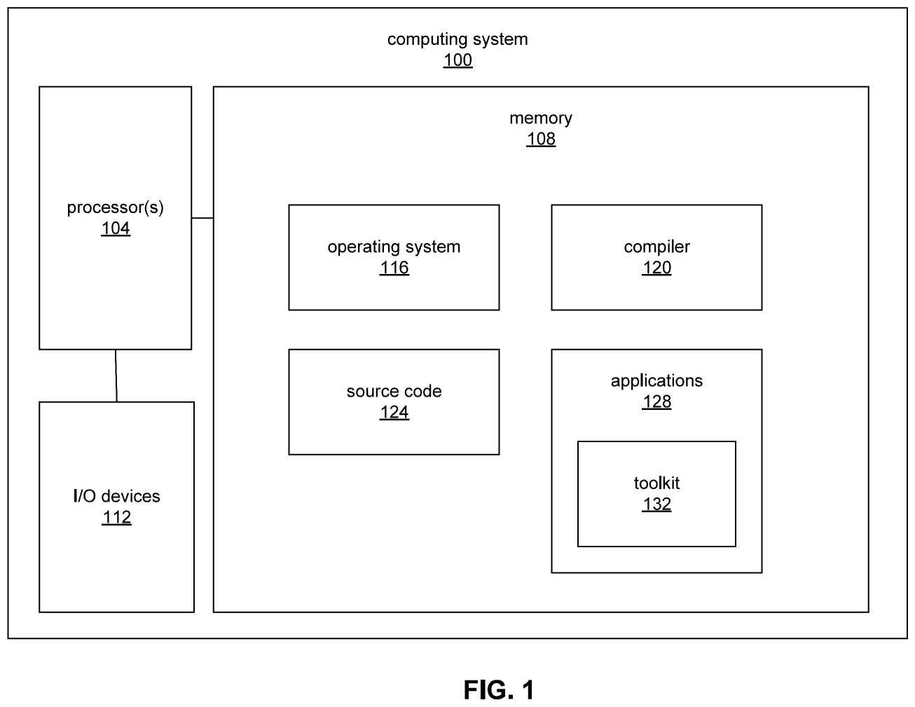

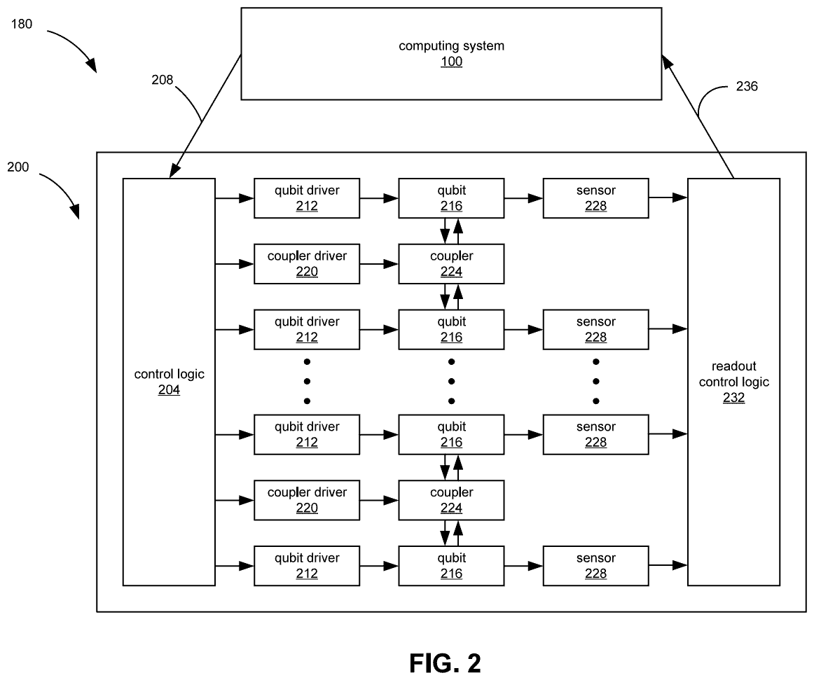

FIG. 1 shows a classical computing system 100 that is configured to execute the encoding of pulses on a set of qubits and any other (preparation) computations that are not performed on the quantum hardware. The classical computing system 100 executes instructions that configure it to send control instructions to quantum hardware and then receive output from the quantum hardware. After executing any preparation computations on the classical computing system 100, the output of the classical computing system 100 (i.e., the Hamiltonian pulse) is then provided as input to quantum hardware. There can be a feedback loop (back and forth process) of performing some computations on the classical computing system 100, which are then fed and used by the quantum hardware. The quantum hardware 200 is for exemplary purposes only and is not meant to be the exact structure of the quantum hardware. As understood by one skilled in the art, the classical computing system 100 in FIG. 1 runs the determination of pulses, etc., and the quantum hardware 200 in FIG. 2 runs the output.

FIG. 2 is an example of a quantum computer 180 that includes exemplary quantum hardware 200 (alternatively referred to herein as “quantum hardware”) that can process the output from the classical computing system 100 according to embodiments of the present invention. A quantum processor is a computing device that can harness quantum physical phenomena (such as superposition, entanglement, and quantum tunneling) unavailable to non-quantum devices. A quantum processor may take the form of a superconducting quantum processor. A superconducting quantum processor may include a number of qubits and associated local bias devices, for instance two or more superconducting qubits. Examples of superconducting qubits include phase qubits, flux qubits, and charge qubits. A superconducting quantum processor may also employ coupling devices (i.e., “couplers”) providing communicative coupling between qubits. Other types of qubits include ion traps, neutral atom qubits, spin qubits (i.e., quantum dots), and photonic qubits.

It is to be understood that the number of qubits, the interaction of qubits, and the configuration of qubits are all intended to be illustrative and non-limiting for example purposes. It should be appreciated that the qubits (and readout resonators which are not shown) can be constructed in various different configurations, and that the quantum hardware 200 illustrated in FIG. 2 is not meant to be limiting.

The quantum hardware 200 has control logic 204 that, in response to receiving control signals 208 from the classical computing system 100 (e.g., according to terms, aspects, etc., of the Hamiltonian pulse), controls a set of qubit drivers 212, each of which is coupled to a qubit 216. In addition, the control logic 204 controls a set of coupler drivers 220, each of which is coupled to a coupler 224 positioned to control interactions between qubits 216. A sensor 228 is coupled to each qubit 216 to detect the qubit state of the qubit 216 at the end of a computation. Readout control logic 232 is coupled to the sensors 228 and generates output 236 that is passed back to the classical computing system 100. The quantum hardware 200, in response to receiving the control signals 208, applies a sequence of quantum gates via the couplers 224 and measurement operations via the sensors 228. The sensors 228 produce classical signals that are communicated back to the classical computing system 100 as output via the readout control logic 232.

Now turning back to FIG. 1, an example illustrates a classical computing system 100, e.g., any type of computer system configured to execute algorithm(s) (including various mathematical computations as understood by one skilled in the art) for applying Hamiltonians on a set of qubits, as discussed herein, such that the result can be input to the quantum hardware 200. The classical computing system 100 can be a distributed computer system over more than one computer. Various methods, procedures, modules, flow diagrams, tools, applications, circuits, elements, and techniques discussed herein can also incorporate and/or utilize the capabilities of the classical computing system 100. Indeed, capabilities of the classical computing system 100 can be utilized to implement elements of exemplary embodiments discussed herein.

Generally, in terms of hardware architecture, the classical computing system 100 can include one or more processors 104 (collectively alternatively referred to herein as a processor 104), computer readable storage memory 108, and one or more input and/or output (I/O) devices 112 that are communicatively coupled via a local interface (not shown). The local interface can be, for example but not limited to, one or more buses or other wired or wireless connections, as is known in the art. The local interface can have additional elements, such as controllers, buffers (caches), drivers, repeaters, and receivers, to enable communications. Further, the local interface can include address, control, and/or data connections to enable appropriate communications among the aforementioned components.

The processor 104 is a hardware device for executing machine-readable instructions that can be stored in the memory 108. The processor 104 can be virtually any custom made or commercially available processor, a central processing unit (CPU), a digital signal processor (DSP), or an auxiliary processor among several processors associated with the classical computing system 100, and the processor 104 can be a semiconductor-based microprocessor (in the form of a microchip) or a macroprocessor.

The memory 108 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 108 can incorporate electronic, magnetic, optical, and/or other types of storage media. Note that the memory 108 can have a distributed architecture, where various components are situated remote from one another, but can be accessed by the processor 104.

The machine-readable instructions in the memory 108 can be for one or more operating systems (OSes) 116, and one or more separate programs, each of which includes an ordered listing of executable instructions for implementing logical functions. The programs can include a compiler 120, source code 124, and one or more applications 128 of the exemplary embodiments. As illustrated, the applications 128 include numerous functional components for implementing the elements, processes, methods, functions, and operations of the exemplary embodiments.

The operating system 116 can control the execution of other computer programs, and provides scheduling, input-output control, file and data management, memory management, and communication control and related services.

The applications 128 can be source programs, executable programs (object code), scripts, or any other entities comprising a set of instructions to be performed. When source programs, then the programs are usually translated via a compiler (such as the compiler 120), assembler, interpreter, or the like, which can be included within the memory 108, so as to operate properly in connection with the OS 116. Furthermore, the applications 128 can be written as (a) an object oriented programming language, which has classes of data and methods, or (b) a procedure programming language, which has routines, subroutines, and/or functions.

The applications 128 include a toolkit 132 that is used to create programs for execution on the classical computing system 100. The toolkit 132 includes modules that perform tasks in combination with the quantum hardware 200. In particular, the toolkit 132 includes a gradient module for estimating gradients of cost functions, and a circuit design module for assisting in the creation of useful pulse programs, both of which will be described herein.

While the compiler 120, the source code 124, and the toolkit 132 are shown residing on the classical computing system 100 coupled to the quantum hardware 200 in the presently illustrated and described embodiment, it should be readily appreciated that these components may reside on separate computing systems having similar or differing components relative to those of the classical computing system 100 in order to generate compiled code for executing by the classical computing system 100 coupled to the quantum hardware 200.

The I/O devices 112 can include input devices (or peripherals) such as, for example but not limited to, a mouse, keyboard, scanner, microphone, camera, etc. Furthermore, the I/O devices 112 can also include output devices (or peripherals), for example but not limited to, a printer, display, etc. Finally, the I/O devices 112 can further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 112 also include components for communicating over various networks, such as the Internet or an intranet. The I/O devices 112 can be connected to and/or communicate with the processor 104 utilizing Bluetooth connections and cables (via, e.g., Universal Serial Bus (USB) ports, serial ports, parallel ports, FireWire, HDMI (High-Definition Multimedia Interface), etc.).

In exemplary embodiments, where the applications 128 are implemented in hardware, the applications 128 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The approaches described herein can employ any suitable quantum hardware, such as quantum hardware 200 illustrated and described above. Additionally or alternatively, a quantum hardware simulator can be employed. The quantum hardware simulator can be any suitable device that can reproduce the behavior of a quantum hardware. While, herein, reference is made to quantum hardware, it is contemplated that a quantum hardware simulator could readily be used in place of a quantum hardware.

The use of continuous degrees of freedom can be useful, particularly when solving certain types of problems such as those encountered in machine learning. It is desirable in machine learning to be able to define a scaffold of a program. The scaffold of the program can specify pulses being defined by time-dependent functions over certain time intervals. The time-dependent functions have parameters that are tunable during an optimization process. Thus, these parameters are not explicitly specified initially. As a result, there is freedom in the shape, amplitude, start and end times, etc. of the pulses.

In machine learning, models are generated that need to be optimized through gradient-based information. The gradients are determined for a cost function that is being minimized (or possibly maximized) in order to evolve the model towards a perceived goal, such as accurately recognizing characters in images. It will be appreciated in other fields that other types of cost functions can be employed to steer the model towards some desired goal. There are many different choices of cost functions that can be utilized. When the parameters of the functions are changed, the cost function generally increases or decreases, and sometimes doesn't change much, if at all. It can be desirable to understand how to change the parameters to more directly approach a desirable result; that is, a minimum or maximum value. It will be appreciated that these minimum or maximum values can be local, in some cases.

The tuning of these parameters is initially done when the program scaffold is created, establishing pulses as a function of time for specific intervals. There is also the optimization process where the parameters are tuned as a function of time based on the data. The gradient of the cost function provides how the cost function behaves as the parameters are changed. Ideally, the gradient of the cost function indicates what parameters to tune to quickly reduce the cost function.

In quantum computing, it's very hard to predict how changes in the parameters will change the state of the system. By determining the gradient of the cost function with respect to a particular parameter being tuned, the relationship between the parameters and the cost function can be understood.

Thus, a method is needed for estimating the gradient of a function with respect to parameters of the time-dependent functions defining the pulses. Further, it is desirable to ensure that the gradients located are meaningful, thus indicating how the parameters are to be tuned.

Once the gradient is estimated, it indicates what parameters to change to reduce the cost function. By iteratively making small changes to the parameters and re-evaluating the gradient based on the new parameter values, it is hoped that a global minimum will eventually be located.

Quantum systems are very complex. A system is being evolved that's mathematically described by a very high dimensional vector space. Because of that, the gradients tend to be hard to obtain, and they tend to have values that are very close to zero due to their high dimensionality. That is, there are not a lot of changes that can be made to the parameters that will have an actual effect on the system, as measured through the cost function. So it can be desirable to structure the program scaffolds so that the gradients are more likely to be meaningful; that is, are useful.

Pulse programming is implemented in different manners for different types of quantum hardware. Analog programming of hardware is used to enable gates to control the evolution of quantum systems. Control of these gates is generally abstracted to facilitate programming quantum computers.

Programming toolkits often enable the implementation of different algorithms without needing to understand how the program is ultimately implemented on the particular quantum hardware. A lot of these toolkits work on this abstract level, permitting the shuffling of the gates around and their rearrangement to implement different algorithms. One wrinkle with the abstraction provided by such toolkits is that issues with current quantum hardware, such as noise, are not forced into consideration. As a result, better results can potentially be achieved by taking into account the issues with the quantum hardware such as how one fine tunes pulses to optimize the circuit. This fact encourages an extra layer of optimization instead of just optimizing the arrangement of these gates.

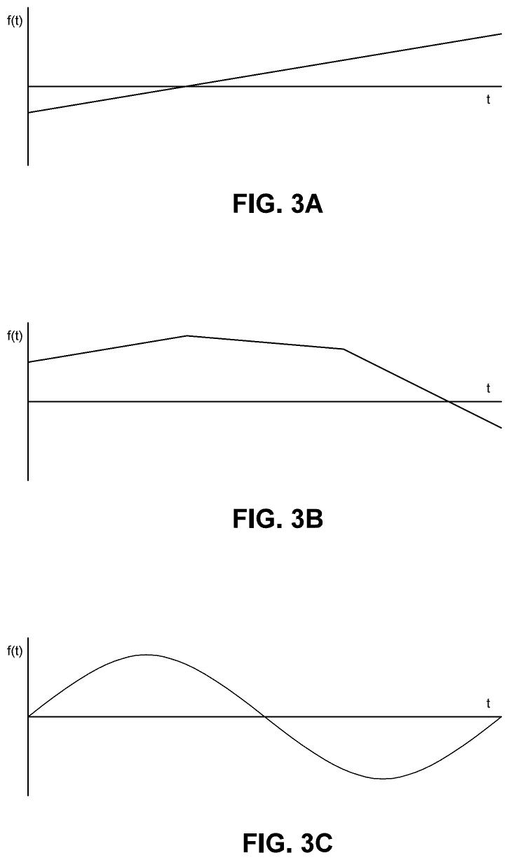

Now, the shape of pulses in a pulse program will be described with reference to FIGS. 3A to 3C. FIG. 3A shows a pulse defined by a linear function of time. Parameters of this linear function include an initial amplitude and its direction, and a slope of how the amplitude changes over time. FIG. 3B illustrates a more complex function of amplitude over time, wherein the function has an initial amplitude and its direction, two inflection points, and slopes during the segments defined by the inflection points. FIG. 3C shows a pulse having a sinusoidal form. Parameters of the function of this pulse include an initial phase, a maximum amplitude, a frequency, and an offset relative to zero, if any.

Many different types of functions such as those illustrated in FIGS. 3A to 3C can be used for defining pulses in quantum computer programs. Further, each of the parameters defining the shapes, amplitudes, phases, start times, and end times of pulses can have an effect on the resulting gradient.

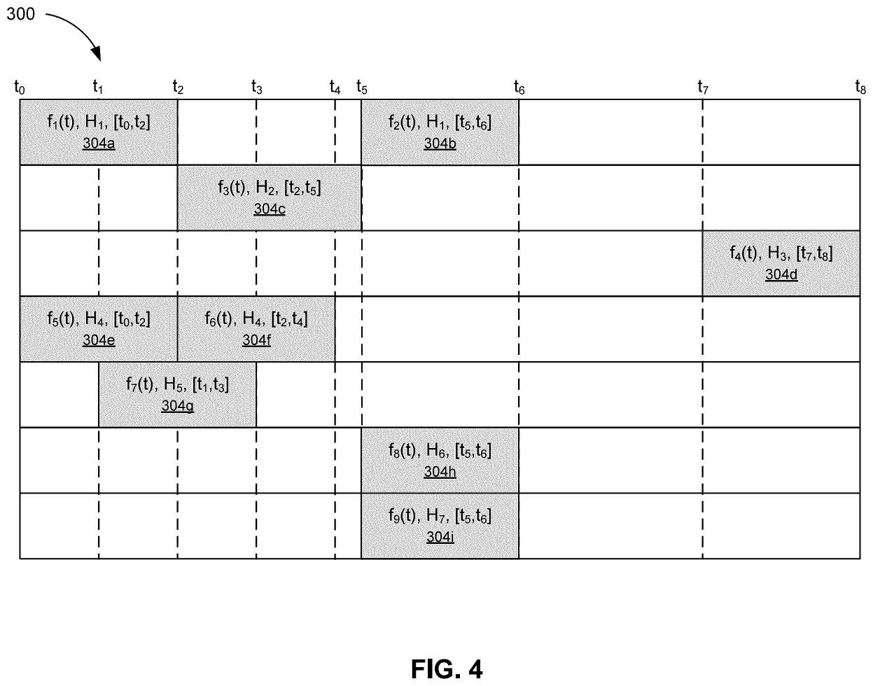

FIG. 4 shows an exemplary pulse program 300 that is executed over a time period from a start time, t₀, to an end time, t₈. The pulse program 300 includes a set of pulses 304a to 304i, collectively alternatively referred to herein as pulses 304. The evolution generator and pulse shape of each pulse, together, act on a particular subsystem of the quantum hardware, where the evolution generator Hₙ is fixed for a given subsystem. A subsystem is one or more qubits of the quantum system. Pulse 304a has a first evolution generator H₁ from t₀ to t₂, and has a shape defined by function ƒ₁(t). Pulse 304b has the first evolution generator H₁ from t₅ to t₆, and has a shape defined by function ƒ₂ (t). Pulse 304c has a second evolution generator H₂ from t₂ to t₅, and has a shape defined by function ƒ₃ (t). Pulse 304d has a third evolution generator H₃ from t₇ to t₈, and has a shape defined by function ƒ₄ (t). Pulse 304e has a fourth evolution generator H₄ from t₀ to t₂, and has a shape defined by function ƒ₅(t). Pulse 304f has the fourth evolution generator H₄ from t₂ to t₄, and has a shape defined by function ƒ₆ (t). Pulse 304g has a fifth evolution generator H₅ from t₁ to t₃, and has a shape defined by function ƒ₇(t). Pulse 304h has a sixth evolution generator H₆ from t₅ to t₆, and has a shape defined by function ƒ₈ (t). Pulse 304i has a seventh evolution generator H₇ from t₅ to t₆, and has a shape defined by function ƒ₉ (t). As will be appreciated, some of the functions ƒ(t) may be time-independent. The structure of the dynamical Lie algebras depends on the algebraic structure of the active evolution generators (whether they commute or can be written as linear combinations, or not), and by the overlapping structure of the intervals.

During different time intervals, different dynamical Lie algebras are active. The structure of the dynamical Lie algebras depends on the algebraic structure of the active evolution generators (whether they commute or can be written as linear combinations, or not), and by the overlapping structure of the intervals.

As will be appreciated, the assembly of such a pulse program as that illustrated in FIG. 4 can be very complex. The proposed pulses to be simultaneously applied to various subsystems of qubits during a time interval, such as during the time interval from t₅ to t₆, when pulses are proposed to be applied to three separate subsystems can result in gradients that are very complex to calculate.

Even the estimation of the gradient with respect to a particular parameter for a single pulse can be very complex in view of the size of the dynamical Lie algebras. The time-dependent unitary U(t) corresponds to the time-dependent evolution due to all H(t) s that are active over that time interval (i.e., all subsystems where the pulses are non-zero). This time-dependent unitary may be alternatively written herein simply as U. Each of these time-dependent unitaries is a square matrix that represents the change in state of the quantum system during the respective pulse. The gradient for any pulse can be determined with respect to any of the parameters \vec{θ} of the pulse for the time interval during which the pulse is active. \vec{θ} is a vector of all of the free differentiable/trainable parameters of the pulses in the program. As noted, the determination of the gradient is complex in view of the size of the dynamical Lie algebra.

The toolkit 132 assists with the design of pulse programs that are feasible to differentiate and with estimating the gradients in order to tune pulse programs. The quantum computer uses pulse programs to calculate expectation values of an observable. The cost function that is desired to be minimized is typically encoded as an observable whose expectation value is calculated using the quantum computer. The quantum computer performs the evolution according to the gates defined in its circuit and then measures an expectation value. That is, the evolution and measurement is repeated multiple times, in so-called “shots”. It is desired to compute the derivative with respect to one parameter of the cost function; i.e., how the expectation value of that observable changes when the parameter determining the evolution is changed.

Computing the gradient involves computing the partial derivative for each parameter. On quantum hardware, this has to be done individually for each parameter in \vec{θ} with at least two executions. The parameter-shift method is used to estimate the gradients for each parameter. This approach is similar to finite difference formulas to compute derivatives. For example, an observable may change according to an unknown function ƒ(x) that can only be queried and for which the functional form is unknown (i.e., standard calculus cannot be performed to compute its derivative). The derivative of ƒ(x) at x₀ can be estimated by computing

$$\frac{df ( {x}_{0} )}{dx} = \frac{f ( {x}_{0} + h / 2 ) - f ( {x}_{0} - h / 2 )}{h}$$

for some small constant h. This method of approximation is called finite differences.

The derivative of a quantum function can be precisely computed in a similar way. First, a quantum function could, for example, be the expectation value of some observable that is measured using a quantum computer. The evolution of the quantum state of the quantum hardware is characterized by a unitary evolution. The quantum function can be said to be

$$f ( \vec{θ} ) = 〈 ψ \vert {U}^{†} ( \vec{θ} ) HU ( \vec{θ} ) \vert ψ 〉 ,$$

where |ψ [symbol] is some initial state of the qubits (i.e., a complex-valued vector). Note that when this is performed on quantum hardware, direct access to this state or the unitary is not available, so, similar to the example above, direct access to the functional form of ƒ(\vec{θ}) is not available, but values from ƒ(\vec{θ}) can be queried.

Once the gradient is obtained, one optimization step is performed by moving all parameters in the opposite direction of their derivatives; that is,

$${\vec{θ}}_{n + 1} = {\vec{θ}}_{n} - γ ∇ f ( {\vec{θ}}_{n} ) ,$$

where n is the step number, γ is a positive real number, and ∇ƒ(\vec{θ}ₙ) is the gradient of ƒ(\vec{θ}) at step n, in order to move towards a lower expectation value. This is referred to as gradient descent.

In order to determine how to tune the expectation values produced by a program with respect to the parameters of the pulses, the gradient with respect to each parameter θᵢ in \vec{θ} is estimated by the gradient module of the toolkit 132 to determine the directions in which the parameters should be shifted in order to reduce the cost function. The quantum hardware is reset to an initial state, the parameters \vec{θ} are shifted by a small amount, and the pulse program is re-executed so that the gradient with respect to each of the parameters θᵢ in \vec{θ} can be re-estimated.

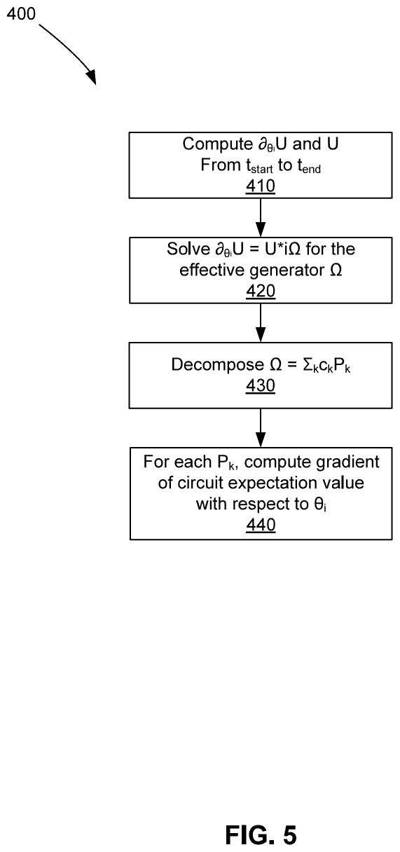

FIG. 5 shows a method 400 used to estimate the gradient with respect to a particular parameter θᵢ in \vec{θ}. The method 400 employs quantum hardware (alternatively referred to as a quantum backend) to perform a particular evaluation to determine how to adjust the parameters of a selected one of the time-dependent unitary/unitaries in a pulse program where there is an initial state preparation and a final measurement. The particular unitary has a start time and an end time, and no other pulses may be active during this period, unless these pulses commute with the unitary for the entire period between the start time and the end time.

The method 400 leverages the fact that the derivative of a time-dependent unitary U(t), with respect to a free parameter θᵢ, has the form

$${\partial }_{{θ}_{i}} U = U * i Ω .$$

Here, U(t) represents all pulses which are active during a time interval [tₛₜₐᵣₜ, t_{end}]. Ω is an operator, and an element of the dynamical Lie algebra generated by the evolution under U(t). Ω is referred to as the “effective generator”.

In this method, a classical differential equation (or coupled set of differential equations) is directly solved to find the form for the effective generator Ω analytically. Once this analytic form is obtained, parameter-shift techniques can be used to compute the gradient of any parameterized circuit which contains the time-dependent unitary U(t).

The method 400 commences with the computation of ∂_{θ}_{ᵢ}U and U from tₛₜₐᵣₜ to t_{end} (410). Any approach for obtaining the solution of classical differential equations (e.g., a numerical differential equation solver) to compute ∂_{θ}_{ᵢ}U and U from tₛₜₐᵣₜ to t_{end} may be used. Note that, if desired, this can be done simultaneously using the so-called adjoint (sensitivity) method. Next, the linear equation system ∂_{θ}_{ᵢ}U=U*iΩ is solved classically for the effective generator Ω (420). Once the equation has been solved for Ω, Ω is decomposed into a sum of operators, Pₖ, which are compatible with the available quantum execution backend (hardware simulator or hardware):

Ω=ΣₖcₖPₖ(430),

where cₖ is a real-valued free parameter for each Pₖ.

Upon decomposing Ω, the general parameter-shift method as described in David Wierichs et al., “General parameter-shift rules for quantum gradients”, Quantum 6, 677 (2022) (hereinafter “Wierichs et al.”), the contents of which are incorporated herein in their entirety, is used to compute the gradient of the circuit expectation value with respect to θᵢ for each Pₖ (440). Two different strategies can be used to calculate the gradient. In a first approach, Ω is treated as is and the generalized parameter-shift rule is performed with 2R+1 shift terms, where R is the number of unique eigenvalue differences of Ω. This first approach is described in Appendix B in Wierichs et al. In a second alternative approach, the parameter-shift gradient is computed for each term of Pₖ, and these parameter-shift gradients are recombined classically, as is described in section 3.5 in Wierichs et al.

If K is the number of elementary gates in the decomposition of Ω=ΣₖCₖPₖ, the latter is the preferred choice as long as K<R. Otherwise, the former method is to be preferred in terms of required quantum resources.

As will be appreciated, the method 400 is repeated for each parameter in \vec{θ} in order to determine the gradient of the cost function with respect to all parameters \vec{θ}.

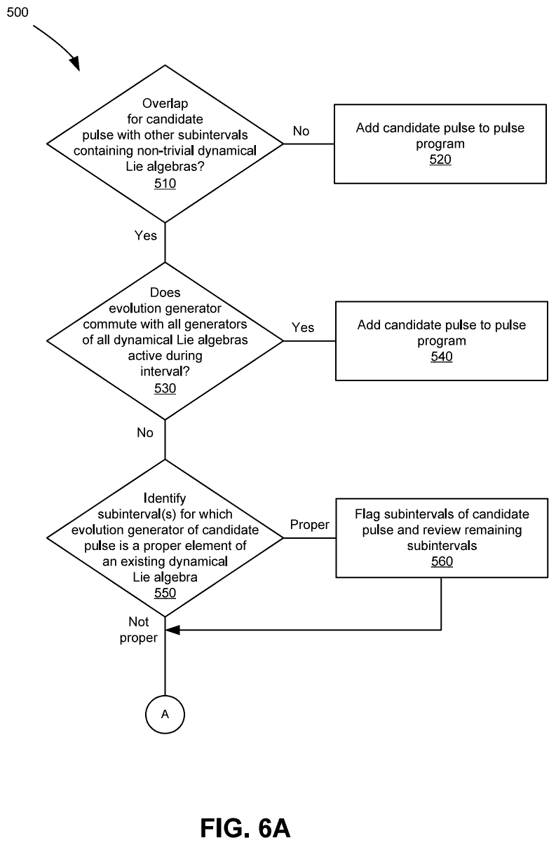

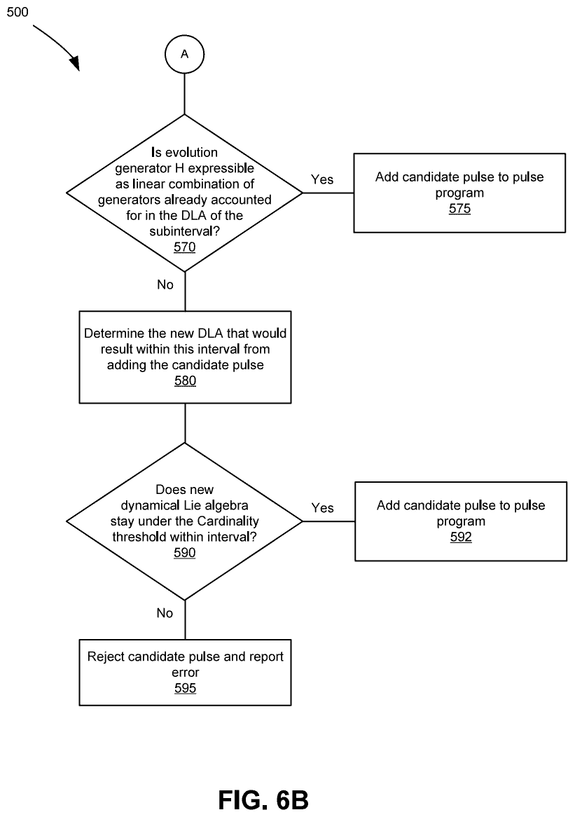

This method 400 may be combined with the method illustrated in FIGS. 6A and 6B and described below, or other techniques which restrict the size of the differential equation which must be solved, allowing for the gradient to be obtained with better practical efficiency.

The result returned by the gradient module is the gradient of the output of the pulse program over the time interval in question with respect to the parameters \vec{θ}. This gradient procedure may be performed for any of the free parameters \vec{θ}, possibly including the times tₛₜₐᵣₜ and t_{end}. It is also performed similarly for any values of the parameters.

In some embodiments, one or more alternative methods may be used by the gradient module to determine the gradient of the output of the pulse program over a time interval. By way of a non-limiting example, the effective generator Ω and its decomposition may be evaluated by solving the differential equation ∂ₜΩ=∂_{θ}_{ᵢ}U+i[Ω,U]. This method is described in Lecamwasam et al., “Quantum metrology with linear Lie algebra parameterisations”, arXiv preprint arXiv: 2311.12446 (2023) (hereinafter “Lecamwasam et al.”), the contents of which are incorporated herein in their entirety.

In order to assist users design pulse programs that are feasible to differentiate, the circuit design module of the toolkit 132 provides a module that analyzes the compatibility of candidate pulses and previously added pulses in the pulse program. The circuit design module enables users to define parameterized candidate pulses and add them to the pulse program, and will report an error if the candidate pulse being added is deemed to cause the gradient of the pulse program to become infeasible to differentiate.

One of the goals of the circuit design module of the toolkit 132 is to provide desired maximum cardinality (or cardinalities, if not the same) for the subalgebras of the dynamical Lie algebra generated by a pulse program. The cardinality of a dynamical Lie algebra is defined as the minimum number of basis elements required to express an arbitrary member of the dynamical Lie algebra as a linear combination of said basis elements. The desired maximum cardinality may be set to a default.

A user sequentially supplies a set of pulse program sub-components (“pulses”) via the circuit design module until a determined threshold is reached. Each pulse is defined using the following:
a list of the subsystems the pulse acts on-typically, the subsystems are qubits, but they may also act on d-dimensional subsystems or subspaces.
the start time tₛₜₐᵣₜ and end time t_{end} of the pulse—these may be left in an indeterminate parameterized form (to be trained)
a pulse shape ƒ(t), declaring its time-dependent amplitude and phase—parts of the pulse specification may be left in an indeterminate parameterized form (to be trained)
a time-independent evolution generator-combined, the pulse and operator will form a time-dependent operator H(t)=ƒ(t)*H
a set of free parameters \vec{θ}, along with their initial values, serving to specify the pulse shape and/or the time interval during which the pulse is active
a cost function, typically obtained as the expectation value (or other statistic) of one or more measurement operators after applying a pulse program

The circuit design module accepts the user's sequentially supplied commands until it is determined that the subalgebra cardinality threshold is reached, or would be crossed. A collective pulse program is considered to cross the supplied cardinality threshold if there is any time interval within the collective pulse program where the cardinality of the dynamical Lie algebra of the pulses active in that interval would cross the supplied threshold. Only new pulses which do not cause the cardinality threshold to be crossed are permitted to be added to the program. When a pulse crosses the cardinality threshold, a warning is raised.

The circuit design module also enables a user to supply all of the pulse program sub-components at once. In this case, the circuit design module processes the pulses to determine one or more subset (some or all) of the pulses that does not cause the inputted pulses to exceed the desired subalgebra cardinalities. In some embodiments, all of the candidate pulses can be provided, together with an order for the candidate pulses, so that the pulses are considered in the order, much in the same way as where the candidate pulses are provided one at a time. The candidate pulses may be received from a user directly via an input interface of the computing system upon which the circuit design module of the toolkit 132 executes, such as a keyboard, touchscreen, etc., via a network interface of the computing device, via a storage medium, or via any other suitable means.

The circuit design module keeps a data structure in memory, which tracks the structure of the dynamical Lie algebra generated by a set of pulses that the circuit design module has analyzed and not rejected. Pulses that satisfy certain desirable conditions discussed below may be added without issue. For a pulse that is determined not to satisfy these conditions, the structure of the dynamical Lie algebra is re-examined after inclusion of this pulse to determine whether the specified cardinality thresholds would be crossed or not with the addition of the pulse.

In order to track the state of the dynamical Lie algebra generated by the pulse program, the data structure may keep track of the following information in memory:
[GEN]: A list of algebraic generators for the current dynamical Lie algebra.
[REP]: A representation (as in the mathematical “representation theory”) of the dynamical Lie algebra, broken down as a set of irreducible subrepresentations. Each generator for GEN can also be broken down to a distinct numerical form for each of these subrepresentations.
[INT]: A splitting of the time domain of the full pulse program into disjoint subintervals, such that the dynamical Lie algebra within each subinterval can be considered “fixed” (not changing cardinality within the subinterval) and “closed” (not interacting with evolution generators from other intervals), and thus treated independently. This splitting may be the same, or different, from the time intervals specified in a user's pulse program, depending on need.

Now referring to FIGS. 6A and 6B, a method 500 of processing candidate pulses of a pulse program carried out by the circuit design module of the toolkit 132 is shown. Whether candidate pulses for a pulse program are being entered one at a time, or some or all candidate pulses have been received prior to processing, candidate pulses are analyzed one at a time to determine if, when added to the previously accepted pulses, the group of pulses exceeds the desired subalgebra cardinalities.

The method 500 starts with the determination of whether the candidate pulse overlaps in time with other subintervals containing non-trivial dynamical Lie algebras (510). If the candidate pulse is determined to not overlap any subintervals that contain non-trivial dynamical Lie algebras, the candidate pulse is added to the pulse program (520). A new one-element “subalgebra” (not technically an algebra if it has only one element) containing the evolution generator H of this candidate pulse can be added to the internal data structure, and the existing list of subintervals is updated so that the interval of this pulse is now included.

If, instead, the candidate pulse is determined to overlap one or more subintervals containing non-trivial dynamical Lie algebras at 510, it is determined whether the evolution generator commutes with all generators of all dynamical Lie algebras active during the entire interval over which the candidate pulse is active (530). If the evolution generator commutes with all generators of all dynamical Lie algebras, the candidate pulse is added to the pulse program (540). The candidate pulse can be added without affecting the cardinality threshold, and thus there is no need to update the internal data structure.

If, instead, it is determined that the evolution generator does not commute with each of the generators of all dynamical Lie algebras over the entire interval at 530, it is determined if there are subintervals of the interval over which the candidate pulse is active where the evolution generator commutes with all generators of all dynamical Lie algebras (550). If there are some subintervals where the evolution generator commutes with all generators of dynamical Lie algebras, the subintervals of the candidate pulse are flagged, and the remaining subintervals are reviewed (560).

For the subintervals for which the evolution generator of the candidate pulse is not a proper element of an existing dynamical Lie algebra as determined at 550, the circuit design module determines if the evolution generator H is expressible as a linear combination of generators already accounted for in the dynamical Lie algebras of each of these subintervals (570). If it is determined that this is the case, then the candidate pulse is added to the accepted pulses in the pulse program (575).

If, instead, it is determined that the evolution generator H is not expressible as a linear combination of generators already accounted for in the dynamical Lie algebras of each of these subintervals at 570, then the new dynamical Lie algebra that results from adding the candidate pulse to the already accepted candidate pulses in the pulse program is determined (580). Then, the circuit design module determines if the new dynamical Lie algebra stays under the cardinality threshold (590). If it is determined that the cardinality threshold is not exceeded at 590, then the candidate pulse is added to the pulse program and the internal data structure is updated with the new interval structure, generators, and representations (592). If the cardinality threshold is exceeded, the circuit design module rejects the candidate pulse and reports an error (595).

Evolution operators which are active at disjoint times commute. That is, if a pulse generated by H is active during the time interval (e.g., t₀ to t₁) of the candidate pulse and a pulse generated by G is active during a non-overlapping time interval (e.g., t₂ to t₃, where t₂>t₁), then we can consider these two pulses to commute for the purposes of the above, even if the time-independent generators H, G do not commute. Further, the dimensions of the representations of any dynamical Lie algebra does not influence the cardinality threshold.

Using the above-described approach, the possibility of obtaining gradients of pulse programs using quantum devices (hardware or hardware simulators) is maintained. These conditions ensure that the dynamical Lie algebra generated by any pulse program remains small at all times throughout the pulse program. This is of interest because dynamical Lie algebras can grow very quickly when working with pulses, reaching sizes that are exponential in the number of qubits. These high-dimensional Lie algebras are difficult to extract useful information from.

To actually obtain the gradients, the method 400 of FIG. 5 or one of the other methods available in the prior art, such as the techniques of Banchi & Crooks or the Maryland group, can be employed. With the gradients provided by automatic differentiation, the optimal values of particular pulse parameters (and hence the optimal shapes) with respect to some cost function can be obtained using a gradient descent algorithm, second-order (e.g., Newton's) method, or other methods that rely on gradient information.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approach described herein can be employed for other modalities.

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A classical computer-assisted method for constructing a pulse program for execution on quantum hardware or a quantum hardware simulator, comprising:
receiving, via a computing system, a candidate pulse for a pulse program to be executed on a quantum computer, the candidate pulse having a time interval defined by a start time and an end time during which the candidate pulse is to be active, a function defining the shape of the candidate pulse, and an evolution generator;
determining, via the computing system, if any pulses of the pulse program containing non-trivial dynamical Lie algebras are active during the time interval of the candidate pulse;
in response to determining that no pulses containing non-trivial dynamical Lie algebras are active during the time interval of the candidate pulse, adding the candidate pulse to the pulse program;
in response to determining that at least one pulse containing non-trivial dynamical Lie algebras is active during the time interval when the candidate pulse is active, determining, via the computing system, if the evolution generator of the candidate pulse commutes with all of the generators of the dynamical Lie algebras of the at least one pulse that is active during the time interval; and
adding the candidate pulse to the pulse program if the evolution generator of the candidate pulse commutes with all generators of the dynamical Lie algebras of the at least one pulse that is active during the time interval.

2. The method of claim 1, further comprising:
in response to determining that the evolution generator of the candidate pulse does not commute with all of the generators of the dynamical Lie algebras of the at least one pulse that is active during the time interval, identifying a first set of subintervals of the candidate pulse for which the evolution generator is a proper element of one or more of the dynamical Lie algebras of the at least one pulse that is active during the time interval, and placing all other subintervals of the candidate pulse in a second set;
determining, for each subinterval in the second set, if the evolution generator of the candidate pulse is expressible as a linear combination of the generators of the dynamical Lie algebras of the at least one pulse that is active during the subinterval; and
adding the candidate pulse to the pulse program if the evolution generator of the candidate pulse is expressible as a linear combination of the generators of the dynamical Lie algebras of the at least one pulse that is active during each subinterval in the second set.

3. The method of claim 2, further comprising:
in response to determining that the evolution generator of the candidate pulse is not expressible as a linear combination of the generators of the dynamical Lie algebras of the at least one pulse that is active during each subinterval in the second set, determining a new dynamical Lie algebra within the time interval from adding the candidate pulse to the pulse program;
determining if the cardinality of the new dynamical Lie algebra exceeds a cardinality threshold within the time interval; and
adding the candidate pulse to the pulse program if the cardinality of the new dynamical Lie algebra is less than or equal to the cardinality threshold within the time interval.

4. The method of claim 3, further comprising:
rejecting addition of the candidate pulse to the pulse program in response to determining that the cardinality of the new dynamical Lie algebra exceeds the cardinality threshold within the time interval.

5. The method of claim 3, further comprising:
reporting an error for the candidate pulse in response to determining that the cardinality of the new dynamical Lie algebra exceeds the cardinality threshold within the time interval.

6. The method of claim 1, further comprising estimating a gradient of the pulse program.

7. The method of claim 6, wherein estimating the gradient comprises:
solving a system of equations comprising one of ∂_{θ}_{ᵢ}U=U*iΩ or ∂ₜΩ=∂_{θ}_{ᵢ}U+i[Ω,U] for an effective generator Ω that is an element of the dynamical Lie algebra generated by the evolution under a time-dependent unitary U, θᵢ being a free parameter characterizing at least one of a shape, an amplitude, a phase, a start time, or an end time of a pulse of the pulse program.

8. A computing system for constructing a pulse program for execution on quantum hardware or a quantum hardware simulator, comprising:
at least one processor;
memory storing machine-readable instructions that, when executed by the at least one processor, cause the computing system to:
receive a candidate pulse for a pulse program to be executed on a quantum computer, the candidate pulse having a time interval defined by a start time and an end time during which the candidate pulse is to be active, a function defining the shape of the candidate pulse, and an evolution generator;
determine if any pulses of the pulse program containing non-trivial dynamical Lie algebras are active during the time interval of the candidate pulse;
add the candidate pulse to the pulse program if no pulses containing non-trivial dynamical Lie algebras are active during the time interval of the candidate pulse;
if at least one pulse containing non-trivial dynamical Lie algebras is active during the time interval when the candidate pulse is active, determine if the evolution generator of the candidate pulse commutes with all of the generators of the dynamical Lie algebras of the at least one pulse that is active during the time interval; and
add the candidate pulse to the pulse program if the evolution generator of the candidate pulse commutes with all generators of the dynamical Lie algebras of the at least one pulse that is active during the time interval.

9. The computing system of claim 8, wherein the machine-readable instructions, when executed by the at least one processor, cause the at least one processor to:
if the evolution generator of the candidate pulse does not commute with all of the generators of the dynamical Lie algebras of the at least one pulse that is active during the time interval, identify a first set of subintervals of the candidate pulse for which the evolution generator is a proper element of one or more dynamical Lie algebras of the at least one pulse that is active during the time interval, and place all other subintervals of the candidate pulse in a second set;
determine if the evolution generator is expressible as a linear combination of generators accounted for in the dynamical Lie algebras of each subinterval in the second set; and
add the candidate pulse to the pulse program if the evolution generator of the candidate pulse is expressible as a linear combination of the generators of the dynamical Lie algebras of the at least one pulse that is active during each subinterval in the second set.

10. The computing system of claim 9, wherein the machine-readable instructions, when executed by the at least one processor, cause the at least one processor to:
if the evolution generator of the candidate pulse is not expressible as a linear combination of the generators of the dynamical Lie algebras of the at least one pulse that is active during each subinterval in the second set, determine a new dynamical Lie algebra within the time interval from adding the candidate pulse to the pulse program;
determine if the cardinality of the new dynamical Lie algebra exceeds a cardinality threshold within the time interval; and
add the candidate pulse to the pulse program if the cardinality of the new dynamical Lie algebra is less than or equal to the cardinality threshold within the time interval.

11. The computing system of claim 10, wherein the machine-readable instructions, when executed by the at least one processor, cause the at least one processor to:
reject addition of the candidate pulse to the pulse program if the cardinality of the new dynamical Lie algebra exceeds the cardinality threshold within the time interval.

12. The computing system of claim 10, wherein the machine-readable instructions, when executed by the at least one processor, cause the at least one processor to:
report an error for the candidate pulse if the cardinality of the new dynamical Lie algebra exceeds the cardinality threshold within the time interval.

13. The computing system of claim 8, wherein the machine-readable instructions, when executed by the at least one processor, cause the at least one processor to estimate a gradient of the pulse program.

14. The computing system of claim 13, wherein the instructions that cause the at least one processor to estimate a gradient of the pulse program include instructions to solve a system of equations comprising one of ∂_{θ}_{ᵢ}U=U*iΩ or ∂ₜΩ=∂_{θ}_{ᵢ}U+i[Ω,U] for an effective generator Ω that is an element of the dynamical Lie algebra generated by the evolution under a time-dependent unitary U, θᵢ being a free parameter characterizing at least one of a shape, an amplitude, a phase, a start time, or an end time of a pulse of the pulse program.

15. A classical computer-assisted method for estimating a gradient on quantum hardware or a quantum hardware simulator, comprising:
computing, via a classical computing system for a pulse program for a quantum system, a time-dependent unitary U and the derivative of the time-dependent unitary U with respect to a free parameter θᵢ within a time interval, the free parameter θᵢ characterizing at least one of a shape, an amplitude, a phase, a start time, and an end time of a pulse;
solving the linear equation system ∂_{θ}_{ᵢ}U=U*iΩ for an effective generator Ω that is an element of the dynamical Lie algebra generated by the evolution under the time-dependent unitary U;
decomposing the effective generator Ω into a sum of operators Pₖ; and
computing, on the quantum hardware or the quantum hardware simulator, the gradient of the circuit expectation value of the quantum system with respect to θᵢ for each operator Pₖ using a parameter-shift method.

16. The method of claim 15, wherein, during the using of the parameter-shift method, the generalized parameter-shift rule is performed with 2R+1 shift terms, where R is the number of unique eigenvalue differences of Ω.

17. The method of claim 15, wherein, during the using of the parameter-shift method, the parameter-shift gradient is computed for each operator Pₖ and the parameter-shift gradient for each operator Pₖ is combined classically.

18. The method of claim 15, wherein the time-dependent unitary U and the derivative of the time-dependent unitary U with respect to the free parameter θᵢ are calculated using numerical methods.

19. A computing system for estimating a gradient on quantum hardware or a quantum hardware simulator, comprising:
at least one processor;
memory storing machine-readable instructions that, when executed by the at least one processor, cause the computing system to:
compute, for a pulse program for a quantum system, a time-dependent unitary U and the derivative of the time-dependent unitary U with respect to a free parameter θᵢ within a time interval, the free parameter θᵢ characterizing at least one of a shape, an amplitude, a phase, a start time, and an end time of a pulse;
solve the linear equation system ∂_{θ}_{ᵢ}U=U*iΩ for an effective generator Ω that is an element of the dynamical Lie algebra generated by the evolution under the time-dependent unitary U;
decompose the effective generator Ω into a sum of operators Pₖ; and
compute, on the quantum hardware or the quantum hardware simulator, the gradient of the circuit expectation value of the quantum system with respect to θᵢ for each operator Pₖ using a parameter-shift method.

20. The computing system of claim 19, wherein the machine-readable instructions, when executed by the at least one processor, cause the at least one processor, during the use of the parameter-shift method, to perform the generalized parameter-shift rule with 2R+1 shift terms, where R is the number of unique eigenvalue differences of Ω.

21. The computing system of claim 19, wherein the machine-readable instructions, when executed by the at least one processor, cause the at least one processor, during the use of the parameter-shift method, to compute the parameter-shift gradient for each operator Pₖ and combine the parameter-shift gradient for each operator Pₖ classically.

22. The computing system of claim 19, wherein the time-dependent unitary U and the derivative of the time-dependent unitary U with respect to the free parameter θᵢ are calculated using numerical methods.
